(19) United States
(12) Patent Application Publication
(10) Pub. No.: US 2016/0144905 A1
(43) Pub. Date: May 26, 2016

(54) DUCT STRUCTURE ON VEHICLE SIDE SURFACE

(71) Applicant: TOYOTA JIDOSHA KABUSHIKI KAISHA, Toyota-shi (JP)

(72) Inventor: Masaaki NISHIURA, Toyota-shi (JP)

(73) Assignee: TOYOTA JIDOSHA KABUSHIKI KAISHA, Toyota-shi (JP)

(21) Appl. No.: 14/945,941

(22) Filed: Nov. 19, 2015

(30) Foreign Application Priority Data
Nov. 21, 2014 (JP) 2014-237206

(51) Int. Cl. B62D 35/00; B62D 25/02

(52) U.S. Cl. CPC B62D 35/00; B62D 25/02

(57) ABSTRACT

A duct structure provided on a side surface of a vehicle includes a first opening portion, a second opening portion, and a duct. The first opening portion is disposed forward of a vehicle rear tire in the vehicle front-rear direction, and open toward the front of the vehicle. The second opening portion is disposed rearward of the first opening portion and forward of the rear tire in the front-rear direction, and open toward the rear of the vehicle or open outward in the vehicle-width direction. The duct extends in the front-rear direction to connect the first opening portion and the second opening portion to each other. The duct includes a first slanted region. The first slanted region is an inner-side portion of the duct in the vehicle-width direction. The first slanted region extends inward in the vehicle-width direction from the second opening portion toward the front of the vehicle.

### INCORPORATION BY REFERENCE

The disclosure of Japanese Patent Application No. 2014-237206 filed on Nov. 21, 2014 including the specification, drawings and abstract is incorporated herein by reference in its entirety.

### BACKGROUND OF THE INVENTION

1. Field of the Invention

The invention relates to a duct structure provided on a side surface of a vehicle to reduce air turbulence around a rear tire.

2. Description of Related Art

According to Japanese Patent Application Publication No. 2013-203096 (JP 2013-203096 A), a flange of a fender liner is provided with a duct, and the duct allows a travel airstream (airstream due to a travelling motion of a vehicle), which flows along a bottom surface of the vehicle, to be discharged from the outer side of a tire housing. A fourth travel airstream discharged from the duct blocks third travel airstreams discharged from the tire housing to the outside of the vehicle. Thus, the fourth travel airstream inhibits the separation of a second travel airstream, which flows along a side surface of the vehicle, from the side surface due to the third travel airstreams.

### SUMMARY OF THE INVENTION

The third travel airstreams are likely to be generated in a front tire housing as described in JP 2013-203096 A. Meanwhile, the flow of a travel airstream in a rear tire housing is likely to differ from that in the front tire housing. Specifically, the air flowing along the side surface of the vehicle is likely to enter the inside of the rear tire housing.

If the air enters the rear tire housing, the air collides with a rear tire, which may increase the travel resistance (air resistance) to the vehicle or may deteriorate the driving stability of the vehicle. However, there is no description on this point in JP 2013-203096 A.

Moreover, the duct described in JP 2013-203096 A is just recessed toward the upper side of the vehicle. That is, the duct has such a structure that the travel airstream flowing along the bottom surface of the vehicle is introduced into the duct through the entirety of a lower portion of the duct. With such a duct structure, when the travel airstream flowing along the bottom surface of the vehicle is introduced into the duct, turbulence is likely to occur inside the duct. As a result, the flow of the fourth travel airstream is likely to be turbulent, which makes it difficult to achieve the above-described effect to be produced by the fourth travel airstream.

The invention provides a duct structure provided on a side surface of a vehicle.

An aspect of the invention relates to a duct structure provided on a side surface of a vehicle and including a first opening portion, a second opening portion, and a duct. The first opening portion is disposed forward of a rear tire of the vehicle in the front-rear direction of the vehicle, and the first opening portion is open toward the front of the vehicle. The second opening portion is disposed rearward of the first opening portion in the front-rear direction of the vehicle and forward of the rear tire in the front-rear direction of the vehicle. The second opening portion is open toward the rear of the vehicle or is open outward in the vehicle-width direction of the vehicle. The duct extends in the front-rear direction of the vehicle to connect the first opening portion and the second opening portion to each other. The duct includes a first slanted region. The first slanted region is an inner-side portion of the duct in the vehicle-width direction, and the first slanted region extends inward in the vehicle-width direction from the second opening portion toward the front of the vehicle.

In the above aspect, the duct may include a second slanted region. The second slanted region is an inner-side portion of the duct in the vehicle-width direction. The second slanted region extends inward in the vehicle-width direction, from a position forward of the first opening portion toward the rear of the vehicle.

In the above aspect, the duct may include a third slanted region. The third slanted region is an outer-side portion of the duct in the vehicle-width direction. The third slanted region extends toward the first slanted region in a direction toward the second opening portion.

In the above aspect, the second opening portion may face a rear wheel housing in which the rear tire is housed.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a side view of a vehicle;

FIG. 2 is a perspective external view illustrating a part of a rocker molding having an inlet;

FIG. 3 is an exploded perspective view of a duct structure;

FIG. 4 is a horizontal sectional view of a duct structure according to a first embodiment of the invention;

FIG. 5 is a horizontal sectional view of a duct structure according to a second embodiment of the invention;

FIG. 6 is a horizontal sectional view of a duct structure according to a third embodiment of the invention; and

FIG. 7 is a horizontal sectional view of a duct structure according to a fourth embodiment of the invention.

### DETAILED DESCRIPTION OF EMBODIMENTS

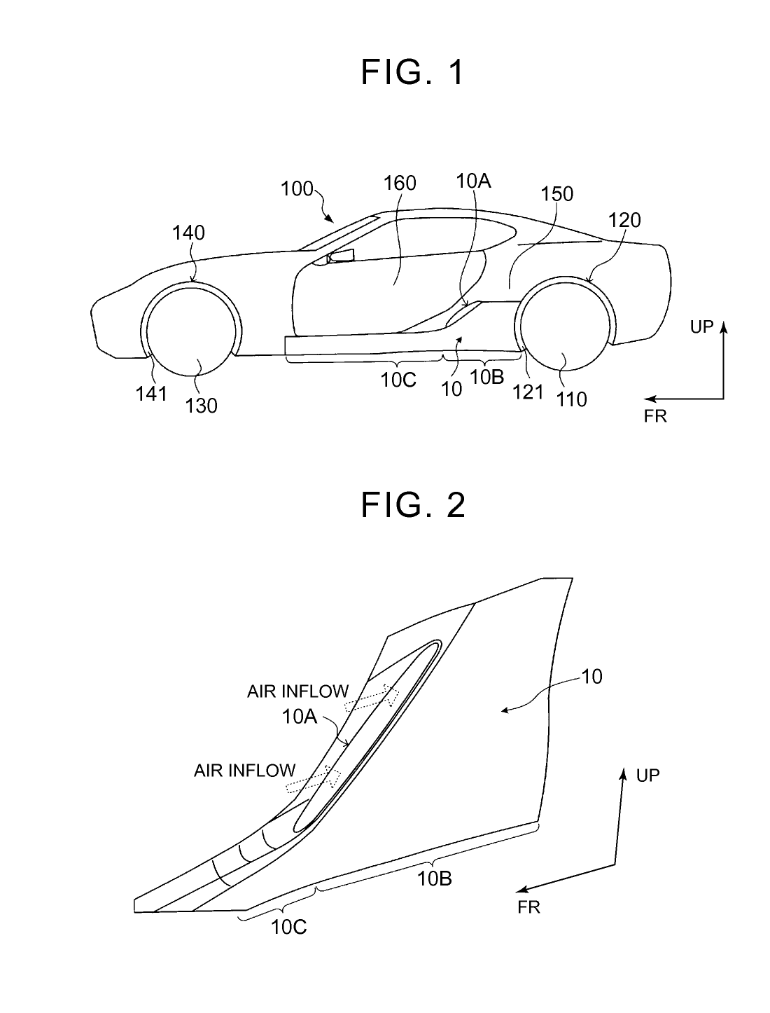

Hereinafter, a first embodiment of the invention will be described. In FIG. 1, an arrow UP indicates the upward direction of a vehicle 100, and an arrow FR indicates the forward direction of the vehicle 100. The direction perpendicular to both of the upward direction UP and the forward direction FR, that is, the direction perpendicular to the sheet on which FIG. 1 is drawn is the width direction of the vehicle 100 (vehicle-width direction).

As illustrated in FIG. 1, the vehicle 100 includes a rear wheel housing 120 in which a rear tire 110 is housed, and a front wheel housing 140 in which a front tire 130 is housed. While only one side surface of the vehicle 100 is illustrated in FIG. 1, the other side surface of the vehicle 100 has the same structure as the structure illustrated in FIG. 1. That is, the structures of the both side surfaces of the vehicle 100 are symmetric with respect to a line perpendicular to the vehicle-width direction and passing through the center of the vehicle 100 in the vehicle-width direction.

A fender liner 121 is disposed in the rear wheel housing 120 at such a position as to face an outer peripheral surface of the rear tire 110. The fender liner 121 is curved in the up-down direction and width direction of the vehicle 100 so as to conform to the outer peripheral surface of the rear tire 110. A fender liner 141 is disposed in the front wheel housing 140 at such a position as to face an outer peripheral surface of the front tire 130. The fender liner 141 is curved in the up-down direction and width direction of the vehicle 100 so as to conform to the outer peripheral surface of the front tire 130.

A rocker molding 10 is fixed to a side panel 150 of the vehicle 100. The rocker molding 10 is disposed forward of the rear wheel housing 120 in the front-rear direction of the vehicle 100.

As illustrated in FIG. 1 and FIG. 2, the rocker molding 10 has an inlet 10A (an example of a first opening portion in the invention) into which the air is introduced as the vehicle 100 travels. The inlet 10A is disposed forward of the rear tire 110 in the front-rear direction of the vehicle 100. Specifically, the inlet 10A is disposed forward of the rear wheel housing 120 in the front-rear direction of the vehicle 100. In addition, the inlet 10A is disposed rearward of a side door 160 in the front-rear direction of the vehicle 100, at such a position that the side door 160 does not come into contact with the inlet 10A.

The inlet 10A is open toward the front of the vehicle 100. Thus, as the vehicle 100 travels (advances), the air flowing along the side surface of the vehicle 100 flows into the inlet 10A. The air introduced into the inlet 10A is discharged to the rear wheel housing 120, as will be described later.

The rocker molding 10 has a duct portion 10B having the inlet 10A, and an extension portion 10C extending from the duct portion 10B toward the front of the vehicle 100. The duct portion 10B is curved so as to bulge outward in the width direction of the vehicle 100. The extension portion 10C is disposed below the side door 160 in the up-down direction of the vehicle 100. The extension portion 10C may be omitted.

In the present embodiment, the vehicle 100 including two side doors 160 has been described. However, the invention is also applicable to a vehicle 100 including four side doors 160. In this case, an inlet 10A may be disposed forward of the rear wheel housing 120 in the front-rear direction of the vehicle 100, and rearward of a rear side door 160 in the front-rear direction of the vehicle 100.

Next, the structure around the rocker molding 10 will be described.

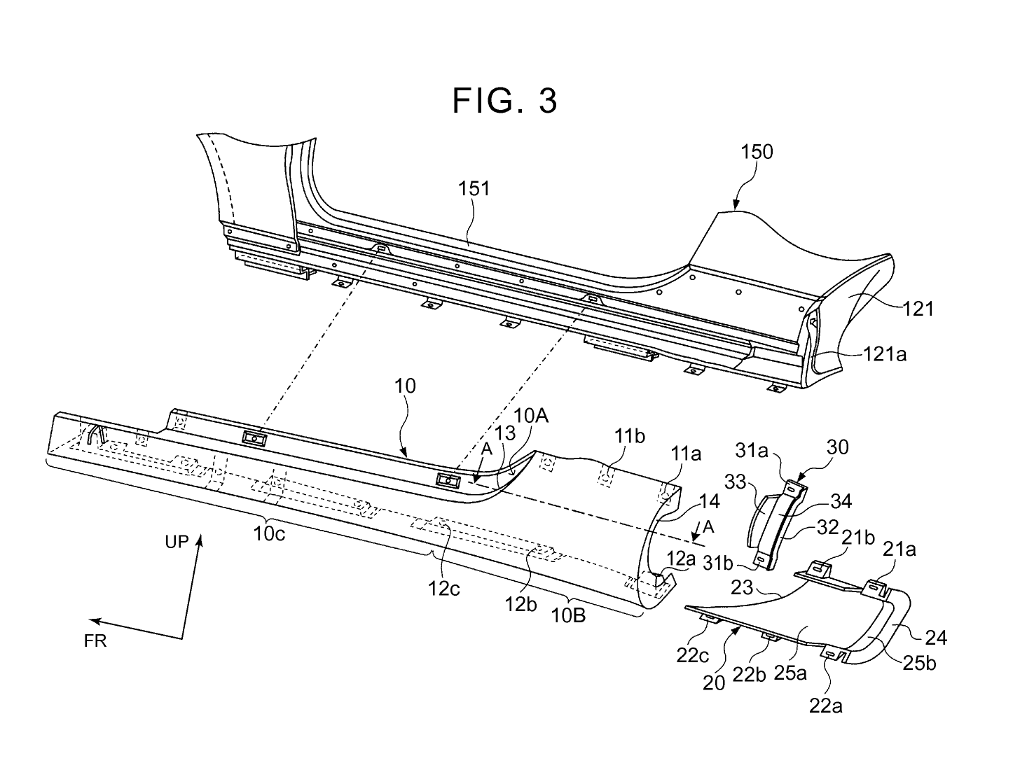

As illustrated in FIG. 3, the rocker molding 10 is fixed to the side panel 150 at a plurality of fixing points. The position and the number of the fixing points may be set as needed. In FIG. 3, the side panel 150 has a door opening portion 151 to be closed by the side door 160.

A first intake duct 20 and a second intake duct 30 are disposed between the duct portion 10B of the rocker molding 10 and the side panel 150. That is, the first intake duct 20 and the second intake duct 30 are disposed inward of the duct portion 10B in the width direction of the vehicle 100. The second intake duct 30 is disposed between the duct portion 10B and the first intake duct 20.

Fixing portions 21a, 21b are provided at an upper end of the first intake duct 20, and fixing portions 22a, 22b, 22c are provided at a lower end of the first intake duct 20. Fixed portions 11a, 11b are provided at positions that are on an inner wall surface of the rocker molding 10 and that are at an upper end of the rocker molding 10. Fixed portions 12a, 12b, 12c are provided at positions that are on the inner wall surface of the rocker molding 10 and that are at a lower end of the rocker molding 10.

The fixing portion 21a is fixed to the fixed portion 11a, and the fixing portion 21b is fixed to the fixed portion 11b. The fixing portion 22a is fixed to the fixed portion 12a, the fixing portion 22b is fixed to the fixed portion 12b, and the fixing portion 22c is fixed to the fixed portion 12c.

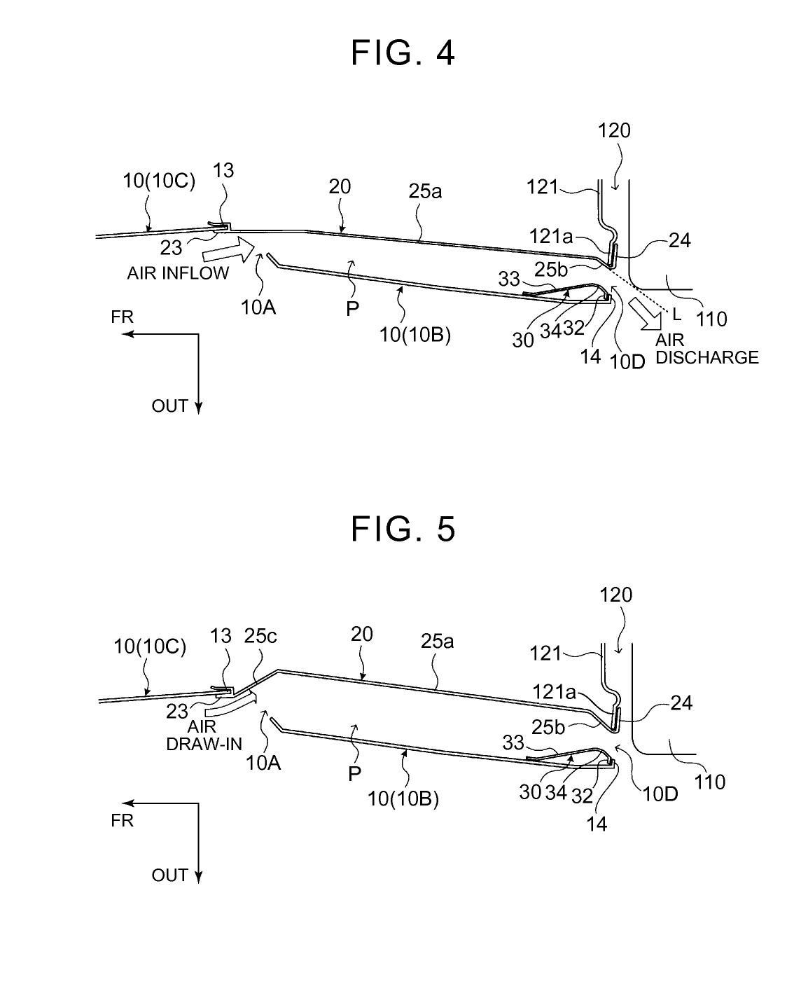

When the first intake duct 20 is fixed to the rocker molding 10, as illustrated in FIG. 4, a passage P through which the air introduced through the inlet 10A flows, is defined between the first intake duct 20 and the duct portion 10B of the rocker molding 10. FIG. 4 is a sectional view taken along the line A-A in FIG. 3. An arrow OUT illustrated in FIG. 4 indicates the outward direction of the vehicle 100 in the vehicle-width direction. The passage P extends from the inlet 10A toward the rear of the vehicle 100. Thus, the air introduced through the inlet 10A flows along the passage P toward the rear of the vehicle 100.

A front end portion 23 of the first intake duct 20, which is a front end portion in the front-rear direction of the vehicle 100, has a shape that conforms to an inner end portion 13 of the duct portion 10B of the rocker molding 10, and is connected to the inner end portion 13. The inner end portion 13 is located in an inner part of the duct portion 10B in the width direction of the vehicle 100. When the front end portion 23 of the first intake duct 20 is connected to the inner end portion 13 of the duct portion 10B, the passage P is turned into a closed space in a plane perpendicular to the front-rear direction of the vehicle 100. The passage P extends in the front-rear direction of the vehicle 100, and is formed into a tubular shape.

A flange 24 the projects on the outside of the passage P is disposed at a rear end portion of the first intake duct 20, which is a rear end portion in the front-rear direction of the vehicle 100. The flange 24 is formed along an outer peripheral surface of the first intake duct 20. As illustrated in FIG. 4, the flange 24 overlaps an outer edge portion 121a of the fender liner 121 in the front-rear direction of the vehicle 100, and is disposed closer to the rear tire 110 than the outer edge portion 121a is.

The first intake duct 20 has a first guide region 25a and a second guide region 25b. The second guide region 25b is disposed rearward of the first guide region 25a in the front-rear direction of the vehicle 100, and is contiguous with the first guide region 25a and the flange 24. A front end portion of the first guide region 25a, which is a front end portion in the front-rear direction of the vehicle 100, is the front end portion 23 described above.

The second guide region 25b of the first intake duct 20 is an example of a first slanted region in the invention. As illustrated in FIG. 4, the second guide region 25b is slanted with respect to the front-rear direction of the vehicle 100, and extends from the first guide region 25a outward in the width direction of the vehicle 100. In other words, the second guide region 25b extends inward in the width direction of the vehicle 100, from an outlet 10D (described later in detail) toward the front of the vehicle 100.

An extension line L is extended along the second guide region 25b from the second guide region 25b toward the rear wheel housing 120. The extension line L extends toward a position outward of the rear tire 110 in the width direction of the vehicle 100. That is, the extension line L does not intersect with the rear tire 110.

As illustrated in FIG. 3, a fixing portion 31a is provided at an upper end of the second intake duct 30, and the fixing portion 31a is fixed to the fixed portion 11a of the rocker molding 10. In this case, the fixing portions 21a, 31a are fixed to the fixed portion 11a, and the fixing portion 31a is disposed between the fixed portion 11a and the fixing portion 21a.

A fixing portion 3 lb is provided at a lower end of the second intake duct 30, and the fixing portion 3 lb is fixed to the fixed portion 12a of the rocker molding 10. In this case, the fixing portions 22a, 3 lb are fixed to the fixed portion 12a, and the fixing portion 3 lb is disposed between the fixed portion 12a and the fixing portion 22a.

A flange 32 that projects toward the duct portion 10B of the rocker molding 10 is disposed at a rear end portion of the second intake duct 30, which is a rear end portion in the front-rear direction of the vehicle 100. The flange 32 is formed along an outer peripheral surface of the second intake duct 30. As illustrated in FIG. 4, the flange 32 overlaps a flange 14 of the rocker molding 10 in the front-rear direction of the vehicle 100. In this case, the flange 32 is disposed closer to the front of the vehicle 100 than the flange 14 is.

The flange 14 is disposed at a rear end portion of the duct portion 10B, which is a rear end portion in the front-rear direction of the vehicle 100, and projects inward in the passage P. The flange 14 is formed along an outer peripheral surface of the duct portion 10B of the rocker molding 10.

As illustrated in FIG. 4, the second intake duct 30 is disposed outward of the second guide region 25b of the first intake duct 20 in the width direction of the vehicle 100. The second intake duct 30 is curved so as to bulge toward the first intake duct 20, and has a first guide region 33 and a second guide region 34. The first guide region 33 is an example of a third slanted region in the invention.

The first guide region 33 extends from an inner wall surface of the duct portion 10B toward the first intake duct 20, in a direction from the upstream side toward the downstream side of the passage P. In other words, the first guide region 33 extends toward the second guide region 25b of the first intake duct 20, in a direction toward the outlet 10D (described later in detail). Thus, the first guide region 33 reduces the width of the passage P in the vehicle-width direction, in the direction from the upstream side toward the downstream side of the passage P, in other words, in the direction toward the outlet 10D (described later in detail).

The second guide region 34 is disposed rearward of the first guide region 33 in the front-rear direction of the vehicle 100, in other words, disposed downstream of the first guide region 33 in the passage P. The second guide region 34 extends from the first guide region 33 outward in the width direction of the vehicle 100. A rear end portion of the second guide region 34, which is a rear end portion in the front-rear direction of the vehicle 100, is connected to the flange 32. Thus, the second guide region 34 is disposed closer to the first intake duct 20 than the flange 32 is.

When the first intake duct 20 and the second intake duct 30 are fixed to the rocker molding 10, the flange 24 of the first intake duct 20 and the flange 32 of the second intake duct 30 are disposed in a single plane. An opening portion surrounded by the flanges 24, 32 is used as the outlet 10D (an example of a second opening portion in the invention) through which air flowing through the passage P is discharged. The outlet 10D adjoins to the second guide region 25b of the first intake duct 20 and the second guide region 34 of the second intake duct 30.

The outlet 10D is disposed rearward of the inlet 10A in the front-rear direction of the vehicle 100, and forward of the rear tire 110 in the front-rear direction of the vehicle 100. The outlet 10D is open toward the rear of the vehicle 100, and faces the rear wheel housing 120. Thus, the air flowing through the passage P is discharged through the outlet 10D into the rear wheel housing 120.

A part that defines the passage P and connects the inlet 10A to the outlet 10D is an example of a duct part in the invention. In the present embodiment, the duct portion 10B, the first intake duct 20, and the second intake duct 30 constitute an example of the duct part in the invention.

The operations and advantageous effects of the present embodiment will be described.

When the vehicle 100 is travelling, the flow velocity of the air at the rear part of the vehicle 100 is likely to be lower than the flow velocity of the air at the front part of the vehicle 100. Thus, a negative pressure is likely to be generated at a position outward of the front wheel housing 140 in the width direction of the vehicle 100, so that the air is likely to move from the inside of the front wheel housing 140 toward the outside thereof.

On the other hand, a negative pressure is less likely to be generated at a position outward of the rear wheel housing 120 in the width direction of the vehicle 100, so that the air is likely to move from the outside of the rear wheel housing 120 toward the inside thereof. Specifically, the air flowing along the side surface of the vehicle 100 is likely to enter a space that is defined between the rear wheel housing 120 and the rear tire 110 and that is located forward of the rear tire 110 in the front-rear direction of the vehicle 100.

When the air enters the rear wheel housing 120 as described above, the air collides with the rear tire 110, resulting in turbulence of airflow. This may increase the travel resistance (air resistance) to the vehicle 100 or may deteriorate the driving stability of the vehicle 100.

In the present embodiment, as will be described below, the airflow around the rear tire 110 is inhibited from becoming turbulent by inhibiting the air flowing along the side surface of the vehicle 100 (specifically, the outer surface of the duct portion 10B) from entering the rear wheel housing 120 while the vehicle 100 is travelling.

In the present embodiment, the second guide region 25b extends inward in the width direction of the vehicle 100, from the outlet 10D toward the front of the vehicle 100. Specifically, the extension line L extends toward a position outward of the rear tire 110 in the width direction of the vehicle 100. Thus, the second guide region 25b makes it possible to guide the air discharged through the outlet 10D, to a position outward of the rear tire 110 in the width direction of the vehicle 100. In this case, as illustrated in FIG. 4, the air discharged through the outlet 10D passes through the space between the rear tire 110 and the flange 14.

It is possible to inhibit the air flowing along the outer surface of the duct portion 10B from entering the rear wheel housing 120 by discharging the air through the outlet 10D in the above-described manner. That is, the air discharged through the outlet 10D pushes the air, which attempts to enter the rear wheel housing 120, back toward the outside of the rear wheel housing 120. If entry of the air into the rear wheel housing 120 is inhibited, the airflow around the rear tire 110 is inhibited from becoming turbulent. As a result, it is possible to inhibit an increase the travel resistance (air resistance) to the vehicle 100 and deterioration of the driving stability of the vehicle 100.

As illustrated in FIG. 4, the width of the passage P in the vehicle-width direction is reduced toward the outlet 10D by providing the second intake duct 30 (particularly, the first guide region 33). This makes it possible to increase the flow velocity of the air heading toward the outlet 10D, thereby increasing the flow velocity of the air discharged through the outlet 10D. Thus, the air discharged through the outlet 10D easily pushes the air, which attempts to enter the rear wheel housing 120, back toward the outside of the rear wheel housing 120.

The first guide region 33 of the second intake duct 30 extends from the duct portion 10B toward the first intake duct 20. With this structure, the air flowing along the first guide region 33 is guided to the second guide region 25b of the first intake duct 20. If the air is guided to the second guide region 25b, the air discharged through the outlet 10D is guided to a position outward of the rear tire 110 in the width direction of the vehicle 100, as described above.

Moreover, as described above, the flange 32 of the second intake duct 30 overlaps the flange 14 of the duct portion 10B, and the second guide region 34 is disposed closer to the first intake duct 20 than the flange 32 is. Thus, when the air flows along the second intake duct 30, collision of the air with the flange 14 of the rocker molding 10 is inhibited. Then, turbulence of airflow occurring as the air flowing through the passage P collides with the flange 14 is inhibited. Thus, according to the present embodiment, it is possible to discharge the air toward the space between the flange 14 and the rear tire 110 while adjusting the flow of air discharged through the outlet 10D.

In the present embodiment, the second intake duct 30 is disposed between the duct portion 10B of the rocker molding 10 and the first intake duct 20, but the second intake duct 30 may be omitted. Even in this case, because the first intake duct 20 has the second guide region 25b, the air discharged through the outlet 10D inhibits the air flowing along the outer surface of the duct portion 10B from entering the rear wheel housing 120, as described above.

Next, a second embodiment of the invention will be described. In the present embodiment, members having the same functions as those in the first embodiment will be denoted by the same reference symbols as those in the first embodiment, and detailed description thereof will be omitted. In the following, differences from the first embodiment will be mainly described. The present embodiment provides a structure that allows the air to easily flow into the inlet 10A.

FIG. 5 is a sectional view illustrating a duct structure according to the present embodiment, and corresponding to FIG. 4. As illustrated in FIG. 5, the first intake duct 20 has a first guide region 25a, a second guide region 25b, and a third guide region 25c. The third guide region 25c is an example of a second slanted region in the invention.

The first guide region 25a is disposed between the second guide region 25b and the third guide region 25c in the front-rear direction of the vehicle 100. The second guide region 25b is disposed rearward of the first guide region 25a in the front-rear direction of the vehicle 100. The third guide region 25c is disposed forward of the first guide region 25a in the front-rear direction of the vehicle 100, and extends forward beyond the inlet 10A in the front-rear direction of the vehicle 100. A front end portion of the third guide region 25c, which is a front end portion in the front-rear direction of the vehicle 100, is the front end portion 23 of the first intake duct 20 described above.

The third guide region 25c is disposed inward of the inlet 10A in the width direction of the vehicle 100. The third guide region 25c is slanted with respect to the front-rear direction of the vehicle 100. The third guide region 25c extends inward in the width direction of the vehicle 100, from the front end portion 23 of the first intake duct 20 toward the rear of the vehicle 100. A region recessed inward in the width direction of the vehicle 100 is defined by the third guide region 25c and the first guide region 25a.

While the vehicle 100 is travelling, the air is likely to flow along the side surface (e.g. the side panel 150, the side door 160) of the vehicle 100. Thus, when the first intake duct 20 has the third guide region 25c, the air flows along the third guide region 25c and is easily drawn into the inlet 10A.

Thus, it is possible to increase the amount of air flowing into the inlet 10A, thereby increasing the amount of air discharged through the outlet 10D. Increasing the amount of air discharged through the outlet 10D makes it possible to more reliably inhibit the air flowing along the outer surface of the duct portion 10B from entering the rear wheel housing 120.

Next, a third embodiment of the invention will be described. In the present embodiment, members having the same functions as those in the first embodiment will be denoted by the same reference symbols as those in the first embodiment, and detailed description thereof will be omitted. In the following, differences from the first embodiment will be mainly described. Like the second embodiment, the present embodiment provides a structure that allows the air to easily flow into the inlet 10A.

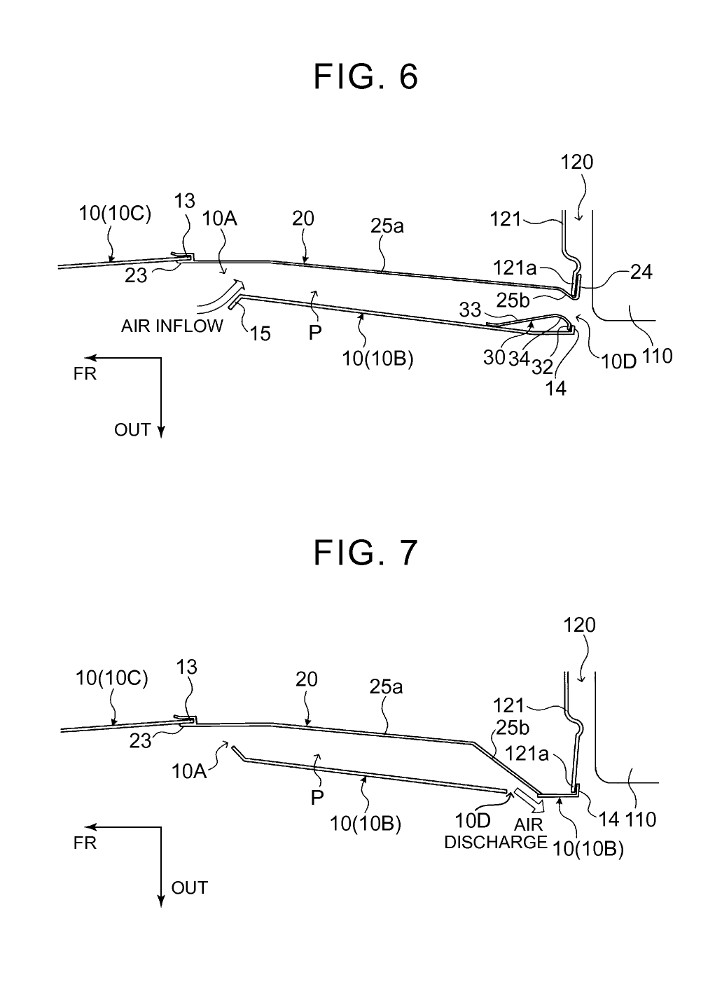

FIG. 6 is a sectional view illustrating a duct structure according to the present embodiment, and corresponding to FIG. 4. As illustrated in FIG. 6, an outer end portion 15, which is a front end portion of the duct portion 10B in the front-rear direction of the vehicle 100, extends forward in the front-rear direction of the vehicle 100 and extends outward in the width direction of the vehicle 100. The outer end portion 15 is disposed outward of the inlet 10A in the width direction of the vehicle 100.

While the vehicle 100 is travelling, the air brought into contact with the outer end portion 15 flows along the outer end portion 15 and is guided into the inlet 10A. Thus, it is possible to increase the amount of air flowing into the inlet 10A, thereby increasing the amount of air discharged through the outlet 10D.

The third embodiment and the second embodiment may be combined together. That is, the first intake duct 20 described in the second embodiment may be used in the third embodiment. Thus, the outer end portion 15 allows the air to easily flow into the inlet 10A, while the third guide region 25c (see FIG. 5) of the first intake duct 20 allows the air to be easily drawn into the inlet 10A.

Next, a fourth embodiment of the invention will be described. In the present embodiment, members having the same functions as those in the first embodiment will be denoted by the same reference symbols as those in the first embodiment, and detailed description thereof will be omitted. In the following, differences from the first embodiment will be mainly described. In the present embodiment, the position of an outlet 10D differs from that in the first embodiment.

FIG. 7 is a sectional view illustrating a duct structure according to the present embodiment, and corresponding to FIG. 4. As illustrated in FIG. 7, the outlet 10D is disposed at a position offset from the rear wheel housing 120. Specifically, the outlet 10D is disposed in the duct portion 10B, at a position forward of the rear wheel housing 120 in the front-rear direction of the vehicle 100, and is open outward in the width direction of the vehicle 100.

The flange 14 of the duct portion 10B is fixed to the outer edge portion 121a of the fender liner 121. The flange 14 overlaps the outer edge portion 121a in the front-rear direction of the vehicle 100.

The second guide region 25b of the first intake duct 20 is contiguous with the outlet 10D disposed in the duct portion 10B. As in the first embodiment, the second guide region 25b is slanted with respect to the front-rear direction of the vehicle 100 and extends from the first guide region 25a outward in the width direction of the vehicle 100.

In the present embodiment, the air flowing through the passage P proceeds along the second guide region 25b and is discharged through the outlet 10D. By discharging the air through the outlet 10D, the air flowing along the outer surface of the duct portion 10B is guided in a direction away from the outer surface of the duct portion 10B. Although the rear wheel housing 120 is disposed rearward of the outlet 10D in the front-rear direction of the vehicle 100, entry of the air into the rear wheel housing 120 is inhibited by guiding the air flowing along the outer surface of the duct portion 10B in a direction away from the outer surface of the duct portion 10B.

Thus, as in the first embodiment, the airflow around the rear tire 110 is inhibited from becoming turbulent due to the air entering the rear wheel housing 120. In the present embodiment, the above-described effect is more reliably achieved by disposing the outlet 10D at a position closer to the rear wheel housing 120.

The air discharged through the outlet 10D flows rearward in the front-rear direction of the vehicle 100 and outward in the width direction of the vehicle 100. It is possible to inhibit turbulence of airflow around the outlet 10D by discharging the air through the outlet 10D in a manner as described above.

If the air discharged through the outlet 10D is headed only outward in the width direction of the vehicle 100, the air collides with the air flowing along the outer surface of the duct portion 10B. As a result, turbulence of airflow is likely to occur. In the present embodiment, the air discharged through the outlet 10D is directed outward in the width direction of the vehicle 100 and rearward in the front-rear direction of the vehicle 100. Thus, it is possible to inhibit the air from entering the rear wheel housing 120 while inhibiting turbulence of airflow around the outlet 10D.

The fourth embodiment may be combined with at least one of the second embodiment and the third embodiment. That is, the structure described in the second embodiment or the structure described in the third embodiment may be used as the structure around the inlet 10A.

Moreover, in the present embodiment, a member corresponding to the second intake duct 30 described in the first embodiment may be provided in order to reduce the width of the passage P in the vehicle-width direction, toward the outlet 10D.

While the inlet 10A is disposed in the rocker molding 10 in the first to third embodiments, the invention should not be limited to this structure. That is, an inlet 10A may be disposed in the body (e.g. the side panel 150) of the vehicle 100. In this case, the rocker molding 10 may be used to form the passage P through which the air is guided from the inlet 10A to the outlet 10D.

What is claimed is:

1. A duct structure provided on a side surface of a vehicle, the duct structure comprising:
a first opening portion disposed forward of a rear tire of the vehicle in a front-rear direction of the vehicle, the first opening portion being open toward a front of the vehicle;
a second opening portion disposed rearward of the first opening portion in the front-rear direction of the vehicle and forward of the rear tire in the front-rear direction of the vehicle, the second opening portion being open toward a rear of the vehicle or being open outward in a vehicle-width direction of the vehicle; and
a duct extending in the front-rear direction of the vehicle to connect the first opening portion and the second opening portion to each other, the duct including a first slanted region, the first slanted region being an inner-side portion of the duct in the vehicle-width direction, and the first slanted region extending inward in the vehicle-width direction from the second opening portion toward the front of the vehicle.

2. The duct structure according to claim 1, wherein the duct includes a second slanted region, the second slanted region being an inner-side portion of the duct in the vehicle-width direction, and the second slanted region extending inward in the vehicle-width direction, from a position forward of the first opening portion toward the rear of the vehicle.

3. The duct structure according to claim 1, wherein the duct includes a third slanted region, the third slanted region being an outer-side portion of the duct in the vehicle-width direction, and the third slanted region extending toward the first slanted region in a direction toward the second opening portion.

4. The duct structure according to claim 1, wherein the second opening portion faces a rear wheel housing in which the rear tire is housed.
